(19) United States
(12) Patent Application Publication
(10) Pub. No.: US 2007/0127314 A1
(43) Pub. Date: Jun. 7, 2007

(54) Method and apparatus for detecting overpressured zone ahead of a drill bit using resistivity and seismic measurements

(75) Inventors: Tsili Wang, Katy, TX (US); Daniel T. Georgi, Houston, TX (US); Michael H. Phillips, Tallahassee, FL (US); Eduard H. Van Wijk, Mauroux (FR); Christian Fulda, Sehnde (DE)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/502,972

(22) Filed: Aug. 11, 2006

Related U.S. Application Data
(60) Provisional application No. 60/708,274, filed on Aug. 15, 2005.

(51) Int. Cl. G01V 1/00

(52) U.S. Cl. 367/41

(57) ABSTRACT

A resistivity logging tool suitable for downhole use includes a transmitter and two spaced apart receivers. The measured signals are inverted to determine the distance to an overpressured zone in the earth formation. The overpressured zone may be a transition zone in resistivity. The direction of drilling may be controlled based on the determined distance. Optionally, seismic-while drilling measurements may be made from which a separate estimate of the distance can be obtained. The SWD® measurements may also be processed to estimate the pore pressure.

### CROSS-REFERENCES TO RELATED APPLICATIONS

This application claims priority from U.S. Provisional Patent Application Ser. No. 60/708,274 filed on 15 Aug. 2005.

### BACKGROUND OF THE INVENTION

1. Field of the Invention

The present invention relates to a method of identifying anomalous zones of abnormally high pore pressures in sedimentary rocks. More specifically, it relates to a method of identifying abnormally pressured zones using measurements while drilling (MWD).

2. Description of the Related Art

At a number of offshore locations, abnormally high pore pressures occur. This could occur if a sand body containing large amounts of water is covered by silt or clay and subsequently buried. If the burial and compaction is rapid enough, “dewatering” and compaction of silts and clays occurs before compaction of the sand. The dewatering of clays, in particular, may result in the formation of relatively impermeable shale layers that slow down the expulsion of water from the underlying sand. The result of this is that the sand may retain high amounts of fluid and the pore pressure in the sand exceeds that which would normally be expected from hydrostatic considerations alone, i.e., the fluid pressure exceeds that which would be expected for a column of water of equivalent height. This phenomenon of overpressuring is well known to those versed in the art.

Accurate prediction of pore pressures that may be expected along the length of a drilling well, especially exploration wells, has traditionally been a difficult industry problem. Where abnormal pressures are known to exist, or may be found unexpectedly along the length of such well bores, accurate prediction of the depth at which such pressures will be encountered may be critical to the economic success of the drilling operation. It is imperative that such overpressured zones be identified and characterized where possible ahead of the drillbit so that remedial action may be taken. The remedial action is to increase the weight of the mud used in drilling so as to avoid the possibility of blowouts.

U.S. Pat. No. 6,694,261 to Huffman teaches a method of using surface seismic data to identify such overpressured zones. Use is made of the fact that in these overpressured zones, the compressional and shear wave velocities (Vₚ and Vₛ) are lower than those of surrounding earth formations. Specifically, the ratio Vₚ/Vₛ can get quite large. These velocity changes can be readily detected using surface seismic data.

The method of Huffman is difficult to extend to deep zones of overpressure due to the lack of resolution of surface seismic data. As noted in U.S. patent application Ser. No. 10/779,885 of Thomann et al., pore pressure predictions from seismic data analysis typically suffer from large uncertainty. There are several contributing factors to this uncertainty, including the inherent uncertainty in the velocity models, the uncertainties in the variation of lithology compared with the data used to build the velocity-pore pressure empirical relationships, and the low vertical resolution of the seismic data. In addition, large and significant pore pressure variation can occur over vertical intervals of rock much thinner than that which seismic data can resolve. Thomann et al. present the use of a bottomhole assembly deployed in a borehole to estimate formation properties. In the invention a source signal is emitted from the bottomhole assembly and at least one signal is received by one or more receivers in the bottomhole assembly. Analysis of the frequency dependent characteristics of the received signal allows the estimation of the formation properties of interest.

The equipment used by Thomann is illustrated in FIG. 1. Several different signals are detected by the receivers. Bottom hole (BHA) assembly 12, which extends into borehole 6, is deployed, in a measurement while drilling system embodiment, on the end of drill string 8. The BHA 12 is schematic in nature only. BHA 12 comprises a center member 10, receivers 16, and, if data processing is performed downhole, will also include data processing components. BHA 12 as referred to herein means all components of the downhole apparatus below drill string 8 but above drill bit 14. Source signal 20 is emitted from a passive source, such as drill bit 14, or an active source (not depicted) in BHA 12, and propagates through first formation 3 to reflector 4, which is the boundary between first formation 3 and second formation 5. Receivers 16A, 16B, 16C, and 16D may detect a number of different types of signals; FIG. 1 depicts examples of four of those types of signals. Receivers 16 can sense both compressional and shear waves signals.

A first receiver signal which will be detected is the direct arrival signal 22, which travels to receivers 16 along central member 10 of BHA 12. If source signal 20 is derived from a passive source, such as drill bit 14, the measurement of direct arrival signal 22 from drill bit 14 to receivers 16 serves to establish the time origin of source signal 20 which is required for the cross-correlation analysis to be discussed below. This time origin determination is made possible from calibration of the frequency dependent travel time along the central member 10 and the known distance from the passive source to the receivers.

One of the limitations of the acoustic methods discussed above is the assumption that there is a sharp transition between normally pressured sediments and overpressure sediments, giving rise to clearly identifiable acoustic reflections. This assumption may be valid for the shallow water applications of Huffman, but the validity of the assumption is questionable in deep overpressured sediments. Dewatering is not an abrupt phenomenon as is discussed below. The result is that there typically is a pressure gradient (and a velocity gradient) associated with overpressured regions. The seismic response from a region with a velocity gradient can be quite complicated and does not fit the simple model assumed in Thomann.

It would be desirable to have an apparatus and a method of using the apparatus that is able to identify overpressured zones at distances greater than 10 m for the purposes of reservoir navigation. Such an apparatus should have a high level of precision and be relatively simple to use. The present invention satisfies this need.

### SUMMARY OF THE INVENTION

One embodiment of the invention is an apparatus for evaluating a subsurface earth formation. The apparatus includes at least one transmitter conveyed in a borehole which produces an electromagnetic field in the earth formation, and at least one receiver conveyed in the borehole which produces a signal in response to the electromagnetic field. The apparatus also includes a processor which determines from the signal a distance to an overpressured zone in the earth formation. The overpressured zone may have a transition zone of resistivity. The processor may determine the distance based in part on a resistivity model. An inversion may be performed to determine the distance. The apparatus may further include an acoustic transmitter which generates acoustic signals in the formation and a plurality of acoustic receivers which receiver acoustic signals at a plurality of depths, and the processor may further use the received acoustic signals for making an additional estimate of the distance to the overpressured zone. The processor may make the additional estimate by further sorting the received acoustic signals into a common-receiver gather, a common-offset gather and/or a common-midpoint gather. The processor may further use the received acoustic signals for estimating a pore-pressure in the overpressured zone. The apparatus may include a conveyance device which conveys the at least one transmitter and the at least one receiver into the borehole, the conveyance device being a drilling tubular or a wireline. The processor may further control a direction of drilling of a bottomhole assembly using the estimated distance. The control of drilling direction may be done using the estimated distance or the additional estimated distance.

Another embodiment of the invention is a method of evaluating an earth formation. An electromagnetic field is produced in the earth formation and a signal is produced in response to the electromagnetic field. The distance to an overpressured zone in the earth formation is determined from the signal. The overpressured zone may a transition zone of resistivity. The distance may be estimated by estimating a resistivity of the overpressured zone. The distance may be determined based at least in part on a resistivity model. The distance may be determined by performing an inversion. The method may further include using at least one acoustic transmitter for generating acoustic signals into the formation, using a plurality of acoustic receivers for receiving acoustic signals at a plurality of borehole depths and using the received acoustic signals for making an additional estimate of the distance to the overpressured zone. Making the additional estimate may further include sorting the received acoustic signals into a common receiver gather, a common offset gather and/or a common midpoint gather. The received acoustic signals may further be used for estimating a pore pressure in the overpressured zone. The electromagnetic signal may be produced by a transmitter on a bottomhole assembly (BHA) conveyed on a drilling tubular and the signal may be produced by a receiver on the BHA. The direction of drilling of the BHA may be controlled based on the determined distance. The control of the drilling direction may be done by using a processor on the BHA.

Another embodiment of the invention is a machine readable medium for use with an apparatus for evaluating a subsurface earth formation. The apparatus includes a downhole assembly conveyed in a borehole in the earth formation. The downhole assembly includes a transmitter which produces an electromagnetic field in the earth formation, and at least one receiver which produces a signal in response to the electromagnetic field. The medium includes instructions that enable a processor to determine from the signal a distance to an overpressured zone in the earth formation. The overpressured zone may have a transition zone of resistivity. The medium may be a ROM, an EPROM, an EAROM, a Flash Memory, and/or an Optical disk.

### BRIEF DESCRIPTION OF THE DRAWINGS

The present invention is best understood with reference to the accompanying figures in which like numerals refer to like elements, and in which:

FIG. 1 (prior art) shows a schematic diagram of a bottom hole assembly in a borehole and the acoustic signals that may be generated and detected for identifying overpressured zones ahead of the drill bit;

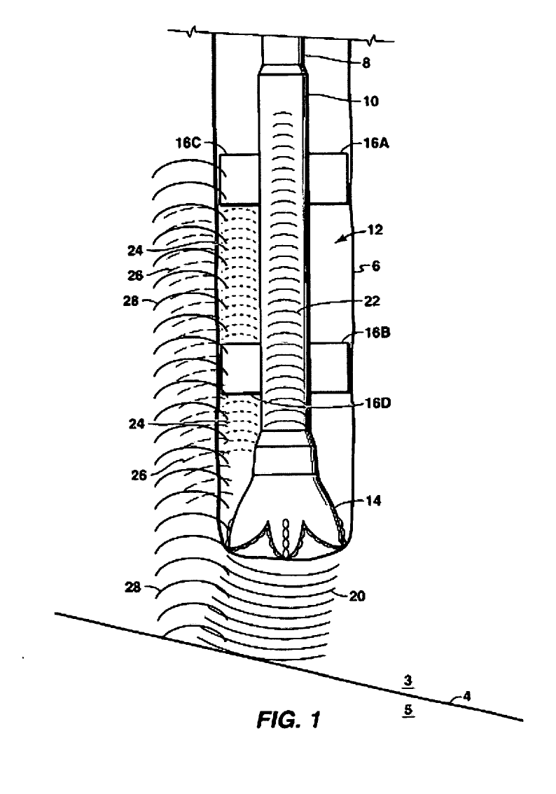

FIG. 2 (Prior Art) shows a logging-while-drilling tool suitable for use with the present invention;

FIG. 3 (prior art) shows the transmitter-receiver configuration of a device suitable for the method of the present invention;

FIG. 4 (prior art) is a view of a resistivity sub of the present invention;

FIG. 5 (prior art) illustrates resistivity changes associated with overpressured shales;

FIG. 6 shows the geometry of a resistivity sensing device in a borehole inclined at an angle to an overpressured formation;

FIGS. 7a, 7b show amplitude and phase measurements as a function of distance from a conductive interface at different inclinations of the borehole to the interface;

FIG. 8 (prior art) illustrates a directional acoustic receiver;

FIG. 9 (prior art) illustrates off-axis sound waves encountering a directional acoustic receiver;; and

FIG. 10 (prior art) shows actual measurements of compressional and shear velocities of unconsolidated sands and shales.

### DETAILED DESCRIPTION OF THE INVENTION

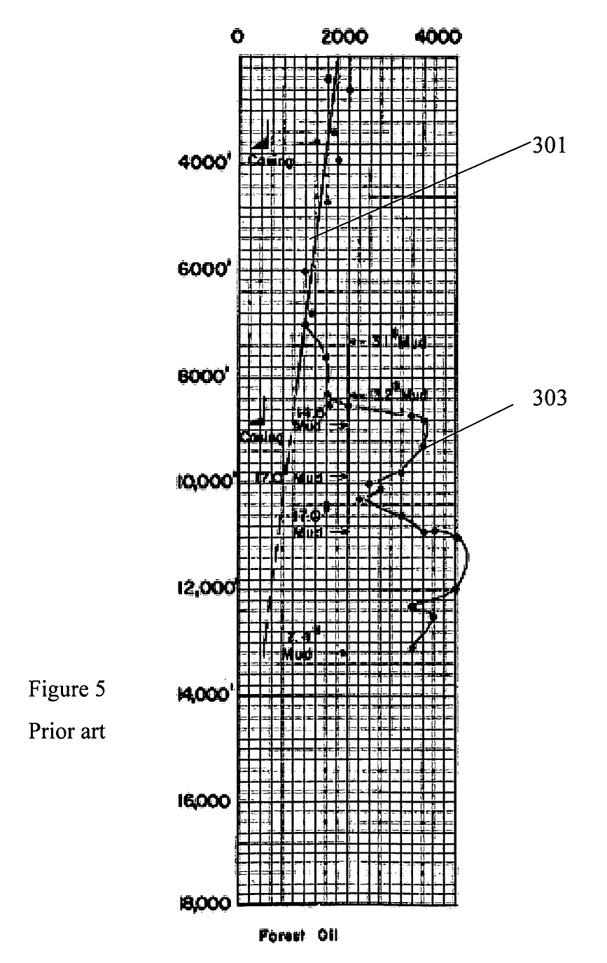

The present invention is a method and apparatus for identification of overpressured formations ahead of a drillbit during the drilling of a borehole. The objective is the same as that in the Thomann reference, but in the present invention, resistivity measurements are used in contrast to the acoustic measurements used in Thomann. The basis for the method lies in empirical observations that the resistivity of overpressured shales is related to the pressure. An example of such empirical data from Wallace et al. is shown in FIG. 5. Plotted therein are resistivity data from a well in the Gulf of Mexico. The ordinate is the depth and the abscissa is the conductivity in millimhos. The normal trend line for resistivity as a function of depth is denoted by 303. Attention is drawn to the points such as 303 which lie in an overpressured section of the well. The conductivity is significantly higher than would be expected from the trend curve. There are numerous other examples of such abnormally high conductivity in overpressured rocks. See, for example, “Physical Properties of Rocks and Principles of Petrophysics”, J. H. Schoen, Elsevier, 1996 (pp. 412-413).

The cause of the abnormally high conductivity in the shale is the same as that which gives rise to the overpressuring in the first place. Due to rapid burial and subsidence, the shales have not been able to lose sufficient water to adjust to the overburden because of the lack of sand that could bleed off the excess water. These shales will carry abnormal quantities of water (relative to normally pressured shales at some distance above) and will for that reason have abnormally high conductivities. The inability to bleed off excess water also results in the increase in formation pore pressure that lowers the compressional and shear velocities (the basis for the Zhou invention). A novel feature of the present invention is the recognition of the fact that resistivity changes occur in overpressured shales and that these changes should be detectable using resistivity measurements responsive to conditions ahead of the drillbit.

Methods of identifying resistivity boundaries are well known in the art. U.S. Pat. No. RE35386 to Wu et al, having the same assignee as the present application and the contents of which are fully incorporated herein by reference, teaches a method for detecting and sensing boundaries in a formation during directional drilling so that the drilling operation can be adjusted to maintain the drillstring within a selected stratum is presented. The method comprises the initial drilling of an offset well from which resistivity of the formation with depth is determined. This resistivity information is then modeled to provide a modeled log indicative of the response of a resistivity tool within a selected stratum in a substantially horizontal direction. A directional (e.g., horizontal) well is thereafter drilled wherein resistivity is logged in real time and compared to that of the modeled horizontal resistivity to determine the location of the drill string and thereby the borehole in the substantially horizontal stratum. From this, the direction of drilling can be corrected or adjusted so that the borehole is maintained within the desired stratum.

A limitation of the method and apparatus used by Wu is that resistivity sensors are responsive to oil/water contacts for relatively small distances, typically no more than 5 m; at larger distances, conventional propagation tools are not responsive to the resistivity contrast between water and oil. Wu discloses the use of a device in which a single transmitter is used and amplitude and phase measurements are made at two spaced apart receivers. U.S. Pat. No. 5,869,968 to Brooks et al. having the same assignee as the present invention discloses a dual propagation resistivity (DPR) tool in which a pair of transmitters are symmetrically disposed about a pair of receivers. With the arrangement in Brooks, it is possible to avoid the effect of mutually coupling between receivers in a propagation resistivity tool. However, even with the DPR device, it is difficult to get the necessary accuracy to see boundaries that are tens of meters from the borehole. It should be noted for the purposes of the present invention, the term boundaries includes boundaries between geologic formations as well as boundaries between different fluids in the subsurface. The resolution that would be needed to be able to identify such overpressure formations is discussed below. We first discuss the basic hardware needed to make such measurements in an MWD environment.

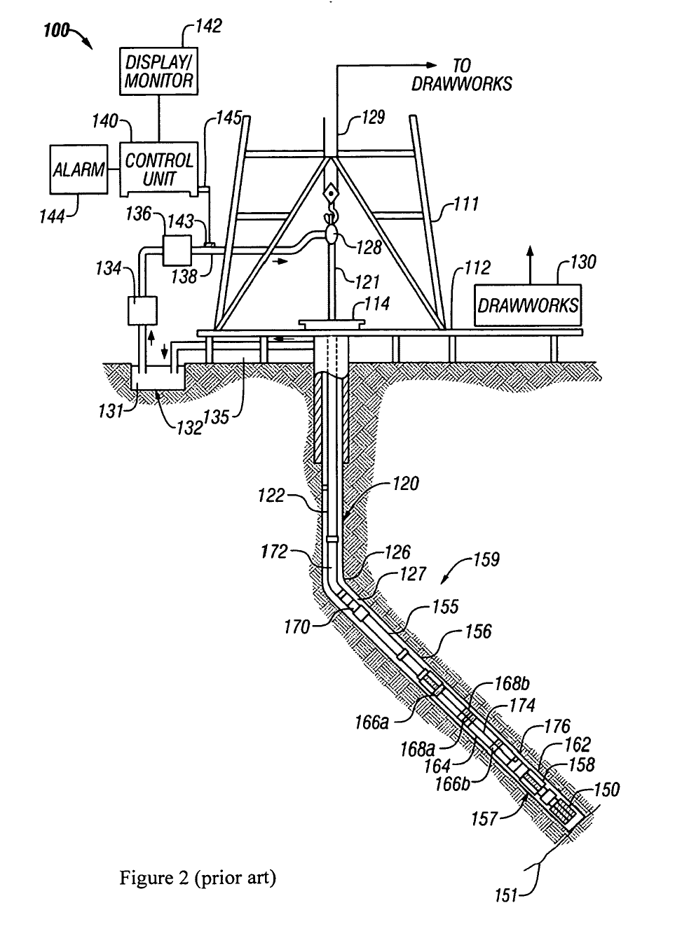

FIG. 2 shows a schematic diagram of a drilling system 110 having a downhole assembly containing an acoustic sensor system and the surface devices according to one embodiment of present invention. As shown, the system 110 includes a conventional derrick 111 erected on a derrick floor 112 which supports a rotary table 114 that is rotated by a prime mover (not shown) at a desired rotational speed. A drill string 120 that includes a drill pipe section 122 extends downward from the rotary table 114 into a borehole 126. A drill bit 150 attached to the drill string downhole end disintegrates the geological formations when it is rotated. The drill string 120 is coupled to a drawworks 130 via a kelly joint 121, swivel 118 and line 129 through a system of pulleys 127. During the drilling operations, the drawworks 130 is operated to control the weight on bit and the rate of penetration of the drill string 120 into the borehole 126. The operation of the drawworks is well known in the art and is thus not described in detail herein.

During drilling operations a suitable drilling fluid (commonly referred to in the art as “mud”) 131 from a mud pit 132 is circulated under pressure through the drill string 120 by a mud pump 134. The drilling fluid 131 passes from the mud pump 134 into the drill string 120 via a desurger 136, fluid line 138 and the kelly joint 121. The drilling fluid is discharged at the borehole bottom 151 through an opening in the drill bit 150. The drilling fluid circulates uphole through the annular space 127 between the drill string 120 and the borehole 126 and is discharged into the mud pit 132 via a return line 135. Preferably, a variety of sensors (not shown) are appropriately deployed on the surface according to known methods in the art to provide information about various drilling-related parameters, such as fluid flow rate, weight on bit, hook load, etc.

A surface control unit 140 receives signals from the downhole sensors and devices via a sensor 143 placed in the fluid line 138 and processes such signals according to programmed instructions provided to the surface control unit. The surface control unit displays desired drilling parameters and other information on a display/monitor 142 which information is utilized by an operator to control the drilling operations. The surface control unit 140 contains a computer, memory for storing data, data recorder and other peripherals. The surface control unit 140 also includes models and processes data according to programmed instructions and responds to user commands entered through a suitable means, such as a keyboard. The control unit 140 is preferably adapted to activate alarms 144 when certain unsafe or undesirable operating conditions occur.

A drill motor or mud motor 155 coupled to the drill bit 150 via a drive shaft (not shown) disposed in a bearing assembly 157 rotates the drill bit 150 when the drilling fluid 131 is passed through the mud motor 155 under pressure. The bearing assembly 157 supports the radial and axial forces of the drill bit, the downthrust of the drill motor and the reactive upward loading from the applied weight on bit. A stabilizer 158 coupled to the bearing assembly 157 acts as a centralizer for the lowermost portion of the mud motor assembly. The use of a motor is for illustrative purposes and is not a limitation to the scope of the invention.

In one embodiment of the system of present invention, the downhole subassembly 159 (also referred to as the bottomhole assembly or “BHA”) which contains the various sensors and MWD devices to provide information about the formation and downhole drilling parameters and the mud motor, is coupled between the drill bit 150 and the drill pipe 122. The downhole assembly 159 preferably is modular in construction, in that the various devices are interconnected sections so that the individual sections may be replaced when desired.

Still referring to FIG. 2, the BHA also preferably contains sensors and devices in addition to the above-described sensors. Such devices include a device for measuring the formation resistivity near and/or in front of the drill bit, a gamma ray device for measuring the formation gamma ray intensity and devices for determining the inclination and azimuth of the drill string. The formation resistivity measuring device 164 is preferably coupled above the lower kick-off subassembly 162 that provides signals, from which resistivity of the formation near the drill bit 150 is determined. A multiple propagation resistivity device (“MPR”) having one or more pairs of transmitting antennae 166a and 166b spaced from one or more pairs of receiving antennae 168a and 168b is used. Magnetic dipoles are employed which operate in the medium frequency and lower high frequency spectrum. In operation, the transmitted electromagnetic waves are perturbed as they propagate through the formation surrounding the resistivity device 164. The receiving antennae 168a and 168b detect the perturbed waves. Formation resistivity is derived from the phase and amplitude of the detected signals. The detected signals are processed by a downhole circuit or processor that is preferably placed in a housing 170 above the mud motor 155 and transmitted to the surface control unit 140 using a suitable telemetry system 172. In addition to or instead of the propagation resistivity device, a suitable induction logging device may be used to measure formation resistivity.

The inclinometer 174 and gamma ray device 176 are suitably placed along the resistivity measuring device 164 for respectively determining the inclination of the portion of the drill string near the drill bit 150 and the formation gamma ray intensity. Any suitable inclinometer and gamma ray device, however, may be utilized for the purposes of this invention. In addition, an azimuth device (not shown), such as a magnetometer or a gyroscopic device, may be utilized to determine the drill string azimuth. Such devices are known in the art and are, thus, not described in detail herein. In the above-described configuration, the mud motor 155 transfers power to the drill bit 150 via one or more hollow shafts that run through the resistivity measuring device 164. The hollow shaft enables the drilling fluid to pass from the mud motor 155 to the drill bit 150. In an alternate embodiment of the drill string 120, the mud motor 155 may be coupled below resistivity measuring device 164 or at any other suitable place.

The drill string contains a modular sensor assembly, a motor assembly and kick-off subs. In one embodiment, the sensor assembly includes a resistivity device, gamma ray device and inclinometer, all of which are in a common housing between the drill bit and the mud motor. The downhole assembly of the present invention preferably includes a MWD section 168 which contains a nuclear formation porosity measuring device, a nuclear density device, an acoustic sensor system placed, and a formation testing system above the mud motor 164 in the housing 178 for providing information useful for evaluating and testing subsurface formations along borehole 126. A downhole processor may be used for processing the data.

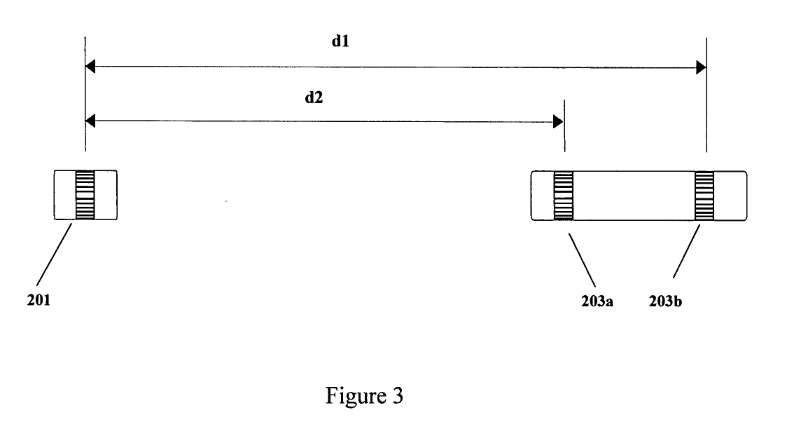

The arrangement of the transmitter 201 and the receivers 203a, 203b is as indicated in FIG. 3. The transmitter is at a distance d1 from the far receiver and a distance d2 from the near receiver. In one embodiment of the invention, the distances d1 and d2 are 17 m and 12 m respectively. One of the novel features of the present invention is the calibration of the receivers to provide the necessary precision of resistivity measurements. This is discussed next.

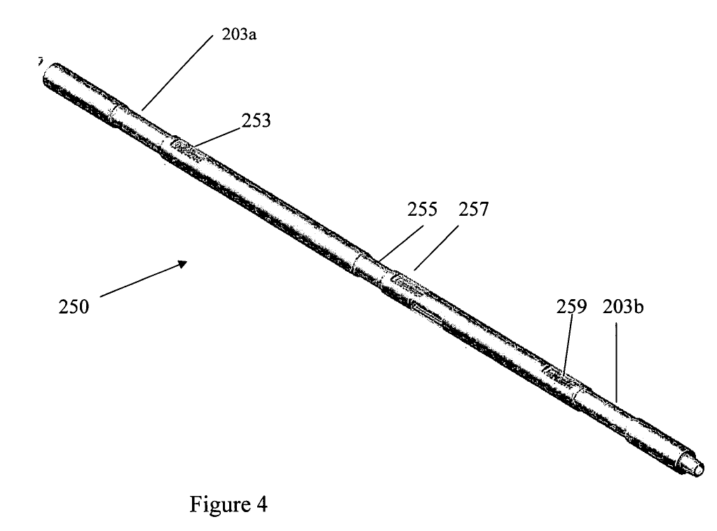

Turning now to FIG. 4, the receiver sub is generally indicated by 250. Included in the receiver sub is a first receiver antenna, designated by 203a, and the corresponding receiver electronics, denoted by 253. The second receiver antenna and the corresponding receiver electronics are denoted by 203b and 259 respectively. An additional calibration antenna 257 may be provided, along with electronics in the center section 255.

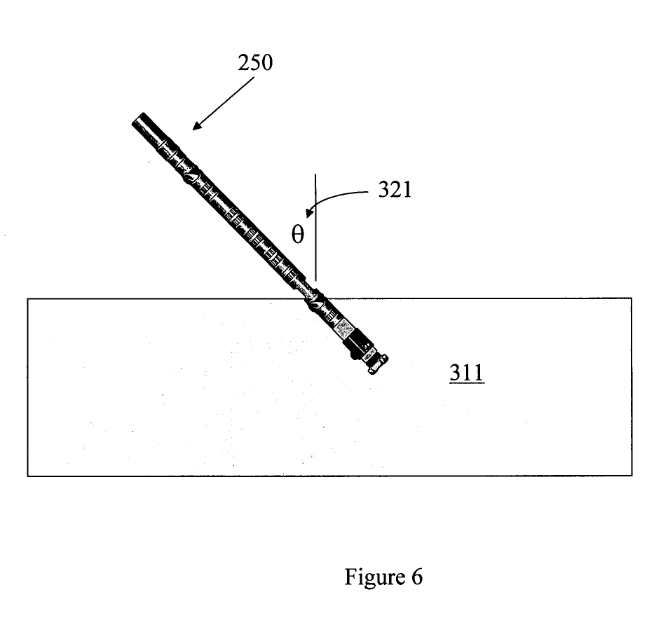

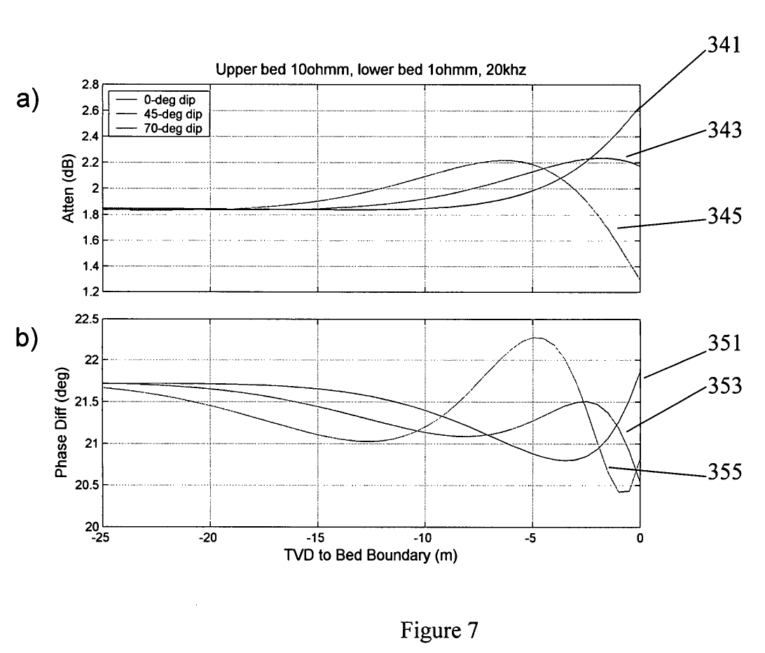

Turning now to FIGS. 6 and 7, results of a simulation of a tool 250 approaching an overpressured formation 311 are shown. The overpressured formation has a resistivity of 1 Ω-m while the overlying medium has a resistivity of 10 Ω-m. The borehole axis makes and angle θ denoted by 321. FIG. 7a shows the amplitude determined resistivity for values of θ equal to 0° (341), 40° (343) and 70° (345) while FIG. 7b shows the phase derived resistivity for values of θ equal to 0° (351), 40° (353) and 70° (355). Based on this, it should be possible to identify a conductive zone (corresponding to an overpressured interval) for distance of about 5 m if measurements can be made with the necessary accuracy. A deep reading resistivity tool with the desired accuracy is disclosed, for example, in U.S. patent application Ser. No. 11/183,139 of Folberth et al., having the same assignee as the present invention and the contents of which are incorporated herein by reference.

The hardware disclosed in Folberth uses a calibration of the two receivers to provide the necessary accuracy and uses a known calibration signal to determine a transfer function between the two receivers. The obtained calibration is then applied to the measurements made by the two receivers to improve the accuracy of the resistivity determination.

It may be noted in FIG. 5 that the resistivity changes associated with the overpressured shale are not characterized by a sharp change in resistivity (as used in the models of FIGS. 7a, 7b): instead, there appears to be a transition zone in resistivity with a gradient in resistivity.

To further confirm the feasibility of the deep-reading LWD resistivity tool, Folberth discloses the use of an inversion technique is employed to process the synthetic responses and determine a distance to a bed boundary. An example is given in Folberth where it is assumed that a resistive bed (hydrocarbon reservoir) possesses a transition zone within which the resistivity drops gradually toward the conductive layer. The method is equally applicable for the problem of overpressure detection where there is a gradient in the conductivity (or resistivity, see FIG. 5.) We found with reasonably accurate measurements, the tool can locate the remote bed boundary even in the presence of a resistivity transition zone with certain uncertainties.

One embodiment of the present invention further uses seismic-while-drilling measurements to identify overpressured formations and to check for a consistency between the seismically derived identification and the resistivity-derived identification. A suitable apparatus for and a method of making seismic measurements while drilling is disclosed in U.S. Pat. No. 6,907,348 to Gaston et al., having the same assignee as the present invention and the contents of which are incorporated herein by reference. In Gaston, the logging tool has at least one source and at least one receiver. Seismic data are acquired, a formation velocity is determined and an angle of investigation is selected. Time shifts are selected such that the source and receiver appears to be collocated at a selected reference depth, and the time shifts are applied to the seismic data. The method provides for imaging reflections in subsurface formations before drilling into them. The method can include cascading seismic sources to improve the signal to noise ratio. One or more quadrants around the wellbore may be investigated.

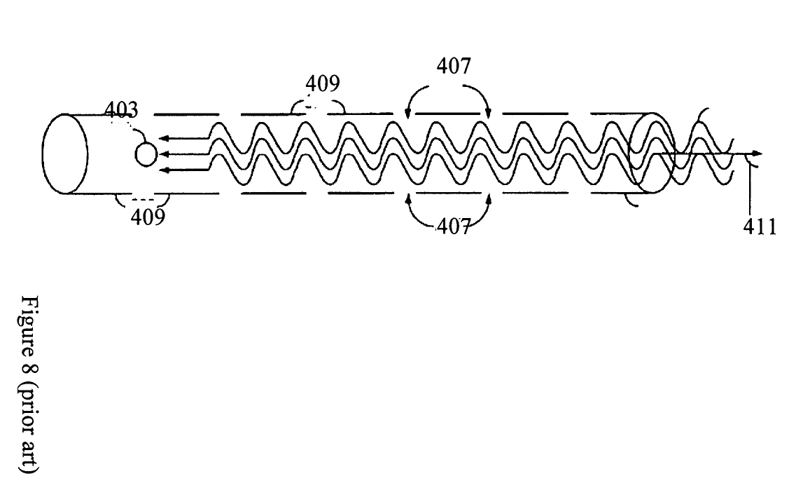

The acquisition geometry for seismic imaging ahead of the drill bit has long been a problem when drilling a well. The particular geometry for down hole seismic data acquisition equipment is that of equipment in a long relatively thin borehole with very little orthogonal aperture in the direction of drilling (width with respect to the direction we are wanting to look in). Such a geometry is illustrated in FIG. 8 for a directional receiver that is analogous to the situation of either an antenna or the shotgun microphone. The directional receiver discriminates against signals 405 arriving from all sectors except those traveling substantially along its axis 411. The sound traveling along the axial direction is unrestricted and is received at the microphone 403 at the end of the barrel.

As illustrated in FIG. 8, microphone receiver element 403 is in a ‘shotgun barrel’ or similar structure 409. The shotgun barrel configuration of FIG. 8 is shown with slits 407 in the sides of the barrel 409.

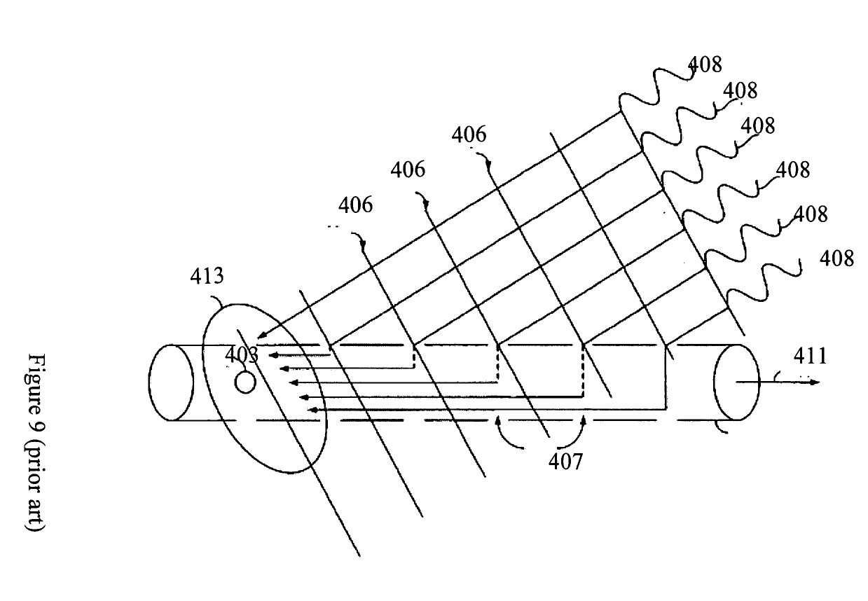

As illustrated in FIG. 9, as off-axis sound waves 408 encounter the barrel 409 then the acoustic path lengths for the incident wavefront 408 are broken up by the slit entrances 407. Each wavefront passing through a slit 407 arrives at the microphone out of phase with it's neighbor. Destructive interference 413 is the result as the sound arrives at the sensor 403, so the off-axis sound is diminished in amplitude.

This off-axis insensitivity can be reversed or modified. For example, when we place helium gas within the shot gun barrel, the inner barrel wave speed is increased so that, for a particular off-axis angle, the microphone receives all signals in-phase. As an alternative to reorienting the microphone, the acceptance angle can be steered off-axis by altering the velocity contrast between the shot gun microphone's interior and exterior.

Effectively, we steer the angle of sensitivity by adjusting the time of arrival of the sound at the microphone. This creates constructive interference of the sound waves for chosen angles, and destructive interference of sound waves from other angles. Gaston further teaches the use of common-source gathers, common-receiver gathers and common-midpoint gathers as the terms are commonly understood with reference to surface seismic data for further analysis of the formation velocities.

Using the teachings of Gaston, the present invention is able to determine compressional velocities in the earth formation. By proper calibration, reflections from interfaces ahead of the drillbit (or at angles to the drillbit) can be evaluated to give reflection coefficients and hence compressional velocities across an interface.

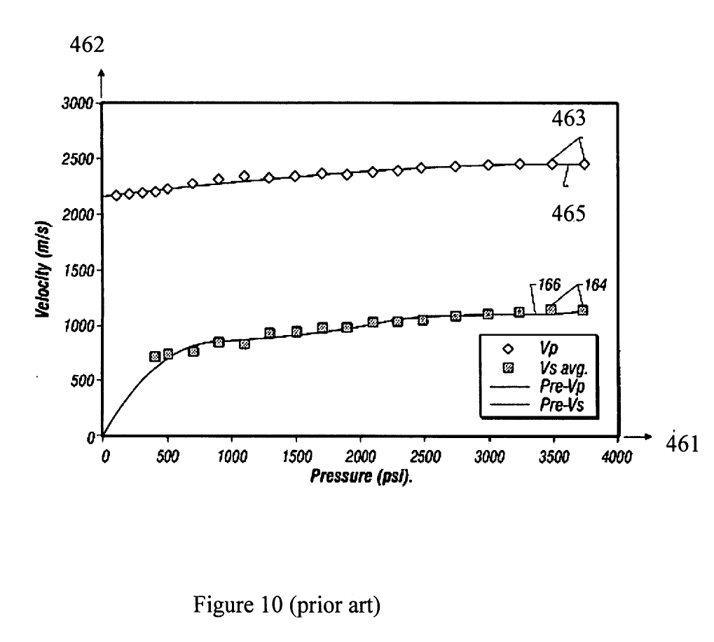

FIG. 10 shows actual laboratory measurements of unconsolidated sands (porosity of 40-45%) at a range of effective stresses from 0 psi to 3750 psi. The abscissa 461 is the effective pressure in pounds per square inch (psi) while the ordinate 462 is the velocity in meters per second. Shown are actual measurements of compressional velocity 463, and averages of 2 orthogonal measurements of shear velocity 464. Also shown in FIG. 10 are a fit to the compressional 465 velocities and predicted values of shear 463 velocities as a function of effective stress. The predicted values of shear velocities are based upon the Gassman relationships between compression and shear velocities using the wet velocity data, Gassmann estimates from the dry frame measurements at pressures down to 200 psi, and the zero stress velocity limit for shear waves. Due to difficulties in measuring shear velocities on laboratory samples, in this data set there are no shear measurements below an effective stress of 400 psi.

As noted above, using the teachings of Gaston it is possible to synthesize common-midpoint (CMP) gathers of reflection seismic data from an interface. The CMP data may be analyzed using known methods to estimate a formation compressional velocity and distance to the interface. The seismically derived distance serves as a consistency check on the resistivity-derived distance and may be referred to as an additional estimate of the distance. In one embodiment of the invention, the two distance estimates may be averaged. At least one of the two distance estimates may be used for controlling the direction of drilling.

The CMP gathers may be analyzed using the methods described, for example, in Huffman to estimate the shear velocity across the interface. Based on FIG. 10, this shear velocity is indicative of the formation pore pressure. This estimate of formation pore pressure may be used for making suitable modifications to the drilling program, such as increasing or decreasing the mud weight to avoid a blowout or to avoid formation damage.

The operation of the transmitters and receivers, and the control of the drilling direction may be controlled by the downhole processor and/or a surface processor. Implicit in the control and processing of the data is the use of a computer program on a suitable machine readable medium that enables the processor to perform the control and processing. The machine readable medium may include ROMs, EPROMs, EAROMs, Flash Memories and Optical disks. The term “processor” as used herein is intended to include Field Programmable Gate Arrays (FPGAs).

While the foregoing disclosure is directed to the preferred embodiments of the invention, various modifications will be apparent to those skilled in the art. It is intended that all such variations within the scope of the appended claims be embraced by the foregoing disclosure.

What is claimed is:

1. An apparatus for evaluating an earth formation, the apparatus comprising:
(a) at least one transmitter conveyed in a borehole which generates an electromagnetic field in the formation;
(b) at least one receiver conveyed in the borehole which produces a signal in response to the generated electromagnetic field; and
(c) a processor which uses the signal to estimate a distance to an overpressured zone in the earth formation.

2. The apparatus of claim 1 wherein the processor estimates the distance when the overpressured zone has a transition zone of resistivity.

3. The apparatus of claim 1 wherein the processor estimates the distance by estimating a resistivity of the overpressured interval.

4. The apparatus of claim 3 wherein the processor estimates the resistivity by further using a resistivity model.

5. The apparatus of claim 1 wherein the processor further performs an inversion for estimating the distance.

6. The apparatus of claim 1 further comprising:
(i) at least one acoustic transmitter which generates acoustic signals into the formation; and
(ii) a plurality of acoustic receivers which receive acoustic signals at a plurality of borehole depths, the plurality of receivers spaced apart axially from the at least one transmitter;
wherein the processor further uses the received acoustic signals for making an additional estimate of the distance to the overpressured zone.

7. The apparatus of claim 6 wherein the processor makes the additional estimate by further: sorting the received acoustic signals into at least one of (A) a common-receiver gather, (B) a common-offset gather, and, (C) a common-midpoint gather.

8. The apparatus of claim 6 wherein the processor further uses the received acoustic signals for estimating a pore-pressure in the overpressured zone.

9. The apparatus of claim 1 further comprising a conveyance device which conveys the at least one transmitter and the at least one receiver into the borehole, the conveyance device selected from (i) a drilling tubular, and (ii) a wireline.

10. The apparatus of claim 1 wherein the processor further controls a direction of drilling of a bottomhole assembly using the estimated distance.

11. The apparatus of claim 5 wherein the processor further controls a direction of drilling of a bottomhole assembly using at least one of (I) the estimated distance, and (II) the additional estimated distance.

12. A method of evaluating an earth formation, the method comprising:
(a) using at least one transmitter conveyed in a borehole for generating an electromagnetic field in the formation;
(b) using at least one receiver conveyed in the borehole for producing a signal in response to the generated electromagnetic field; and
(c) using the signal for estimating a distance to an overpressured zone in the earth formation.

13. The method of claim 12 wherein estimating the distance further comprises a model which includes a transition zone of resistivity for the overpressured zone.

14. The method of claim 12 wherein estimating the distance further comprises estimating a resistivity of the overpressured zone.

15. The method of claim 14 wherein estimating the resistivity further comprises using a resistivity model.

16. The method of claim 12 wherein estimating the distance further comprises performing an inversion.

17. The method of claim 12 further comprising:
(i) using at least one acoustic transmitter for generating acoustic signals into the formation;
(ii) using a plurality of acoustic receivers for receiving acoustic signals at a plurality of borehole depths; and
(iii) using the acoustic signals for making an additional estimate of the distance to the overpressured zone.

18. The method of claim 12 wherein making the additional estimate further comprises:
sorting the received acoustic signals into at least one of (A) a common receiver gather, (B) a common offset gather, and, (c) a common-midpoint gather.

19. The method of claim 17 further comprising using the acoustic signals for estimating a pore-pressure in the overpressured zone.

20. The method of claim 12 further comprising conveying the at least one transmitter and the at least one receiver into the borehole using a device selected from (i) a drilling tubular, and (ii) a wireline.

21. The method of claim 1 1 further comprising controlling a direction of drilling of a bottomhole assembly using the estimated distance.

22. The method of claim 17 further comprising controlling a direction of drilling of a bottomhole assembly using at least one of (I) the estimated distance, and (II) the second estimated distance.

23. The method of claim 19 further comprising altering a mud-weight based on the estimated pore pressure.

24. A computer-readable medium for use with an apparatus for evaluating an earth formation, the apparatus comprising:
(a) at least one transmitter conveyed in a borehole which generates an electromagnetic field in the formation; and
(b) at least one receiver conveyed in the borehole which produces a signal in response to the generated electromagnetic field;
the medium comprising instructions which enable a processor to use the signal to estimate a distance to an overpressured zone in the earth formation.

25. The medium of claim 23 further comprising at least one of (i) a ROM, (ii) an EPROM, (iii) an EAROM, (iv) a flash memory, and (v) an optical disk.
